(19) United States
(12) Patent Application Publication
(10) Pub. No.: US 2019/0311029 A1
(43) Pub. Date: Oct. 10, 2019

(54) METHOD AND SYSTEM FOR DYNAMIC CONTENT GENERATION AND ASSESSMENT

(71) Applicant: Extramarks Education India Pvt Ltd, Noida (IN)

(72) Inventors: Atul Kulshrestha, Noida (IN); Swagata Roy, Noida (IN)

(21) Appl. No.: 16/144,523

(22) Filed: Sep. 27, 2018

(30) Foreign Application Priority Data
Apr. 6, 2018 (IN) 201811013308

(51) Int. Cl. G06F 17/24; G06F 17/30; G09B 7/00

(52) U.S. Cl. CPC G06F 17/248; G09B 7/00; G06F 17/243; G06F 17/30634

(57) ABSTRACT

The present invention is related to a method and system of generating and assessing a question paper based on the various pre-defined parameters selected by a first user. The method includes selecting a type of mode from among a programmed and a semi-automatic programmed mode of question paper generation and assessment to obtain standardized question papers with minimal number of parameters required from the user as inputs. Further, the generated question papers are evaluated either automatically by the system or provides the first user benefit of manually evaluating responses to the questions and provide remarks. Moreover, the generated question paper by a first user may be shared with other similar first users. The said method and the system enables a more standardized, robust and convenient system for generating and assessing question papers that has significantly higher processing capabilities and is time-saving.

### FIELD OF THE INVENTION

The present invention generally relates to dynamic content generation and assessment and, more particularly, to a method and system for generating and assessing a customised question paper based on selected minimal pre-defined parameters.

### BACKGROUND OF THE INVENTION

The rapid development of computer systems and associated applications has enabled intelligent, dynamic and quick content generation processes allowing an end-user (“herein end-user refers to any person creating the question paper”) to create content as per the requirement of the educational/vocational courses.

Moreover, the end-user has been able to use the content generation systems to develop assessment examinations for evaluating the knowledge level and learning capabilities of the end-user. Such automated content generation systems have demonstrated to be beneficial over traditional methods of manually generating and assessing examinations, since the automated content generation systems renders faster results with minimized errors. Also, the demand for automatic and dynamic content generation systems is ever-rising due to exponential increase in number of educational institutions and learning centers across the globe.

However, the existing automated content generation systems may provide methods of question paper generation system, requiring extensive effort by the end-user to create the question paper by first manually creating a template/structure/format of the paper and second selecting each question manually from the selected course sections. Such generated question papers are less standardized and require extensive manual efforts, thereby resulting into time-consuming and labor-intensive effort by the end-user.

Additionally, the questions generated through existing automated content generation system provides the same set of questions for all the students in a particular question paper and lacks a differential evaluation systems basis varied level of understanding of the students. Therefore, there exists a need for an improvised automated content generation system that allows minimized manual intervention with customized questions being generated for testing a student's learning ability basis his/her knowledge.

### SUMMARY OF THE INVENTION

The present disclosure, in accordance with several embodiments of the invention, provide an automated content generation and assessment system wherein the end-user is capable of selecting a programmed mode of question paper generation or a semi-programmed mode of question paper generation through which the end-user is enabled to input a minimal set of pre-defined parameters to generate such question papers. Further, the assessment of generated question papers is carried out either automatically based on the matching of responses associated with each question fetched from the stored repository or manually by providing marks corresponding to each question and remarks by the end-user.

In an embodiment, a method to generate and assess a question paper is described. The method includes providing a first user an option to select various kinds of modes from among a plurality of modes based on parameters selected by the first user, fetching a plurality of questions automatically from a stored repository based on the parameters. Such parameters are associated with each of the questions stored in the repository wherein the parameters are indicative of characteristic properties related to each question. The method further includes generating the question paper based on the associated parameters and at least one mode selected by the user.

Furthermore, the method includes obtaining a plurality of responses associated to said questions from a plurality of second user wherein each of the responses are assigned with at least one or more question type, assessing the said responses obtained from the plurality of second user wherein the assessment is validated automatically and manually by first user and thereby generating a performance report based on said assessment.

Moreover, the invention discloses a dynamic content generation and assessment system wherein the system comprises a generation module configured to generate question papers based on a plurality of modes, a set of first pre-defined parameters and a set of second pre-defined parameters selected by the first user. Based on the selection, a plurality of questions are fetched from a stored repository to automatically populate in the selected template. The generated question paper is then provided to the second user devices. The plurality of responses obtained from the second users is then fed as input to the assessment module which is configured to assess the question paper. The performance reports of each of the plurality of second users is generated using a report generation module.

### BRIEF DESCRIPTION OF THE DRAWINGS

The invention has other advantages and features which will be more readily apparent from the following detailed description of the disclosure and the appended claims, when taken in conjunction with the accompanying drawings. Different numeral references on figures designate corresponding elements. The same numbers are used throughout the drawings to reference like features and components. The detailed description is described with reference to the accompanying figure(s).

FIG. 1 illustrates a network diagram of a dynamic content generation and assessment system that describes the interaction between user devices and the generation and assessment of question papers, in accordance with an implementation of the present disclosure.

FIG. 2 illustrates a computing system describing the different modules 208 in the dynamic content generation and assessment system wherein the plurality of data is stored in the data module 220.

FIG. 3 depicts an overview of the method to generate and assess a customised question paper wherein the first user is interacting with the computing system and its several modules to generate question paper and evaluate the responses provided by the plurality of second users, in accordance with the embodiments of the present invention.

FIG. 4 illustrates a detailed method to generate and assess a customised question paper describing the various modes and set of pre-defined parameters to be selected by the first user to generate the question paper.

### DETAILED DESCRIPTION OF THE INVENTION

While the invention has been disclosed with reference to certain embodiments, it will be understood by those skilled in the art that various changes may be made and equivalents may be substituted without departing from the scope of the invention. In addition, many modifications may be made to adapt to a particular situation or material to the teachings of the invention without departing from its scope.

Throughout the specification and claims, the following terms take the meanings explicitly associated herein unless the context clearly dictates otherwise. The meaning of “a”, “an”, and “the” include plural references. The meaning of “in” includes “in” and “on.” Referring to the drawings, like numbers indicate like parts throughout the views. Additionally, a reference to the singular includes a reference to the plural unless otherwise stated or inconsistent with the disclosure herein.

The invention in its various embodiments proposes a system and method for generating and assessing question papers wherein a first user has the option to generate customised question papers based on certain pre-defined parameters such as but not limited to difficulty level of the question, type of questions, and the question source. The question paper may be assigned to either an entire students of a class/section or a group of selected students. The system enables a user to create either a difficult, moderate or an easy question paper based on difficulty level of the questions associated with each of the plurality of questions stored in the repository.

In one implementation, a plurality of pre-defined parameters can be associated with a plurality of questions and stored in a data repository. The questions thus stored may be accumulated from various sources, such as educational institutions, researchers, and academicians and may be manually entered by the teachers while generating the question paper. The parameters are used to categorize each of the questions such that the questions are easily selected during generation of the question paper.

The pre-defined parameters may be understood as a key value that is indicative of a characteristic or property of a question. In one example, the parameters are selected from a set comprising of a chapter, topology, topic, subject, difficulty, class, section, and term. The parameters associated with a set of questions are flexible, that is, the end-user can select from among a set of predefined parameters that can be associated with one or more of the questions. Each of the parameters is explained at a later stage in the description.

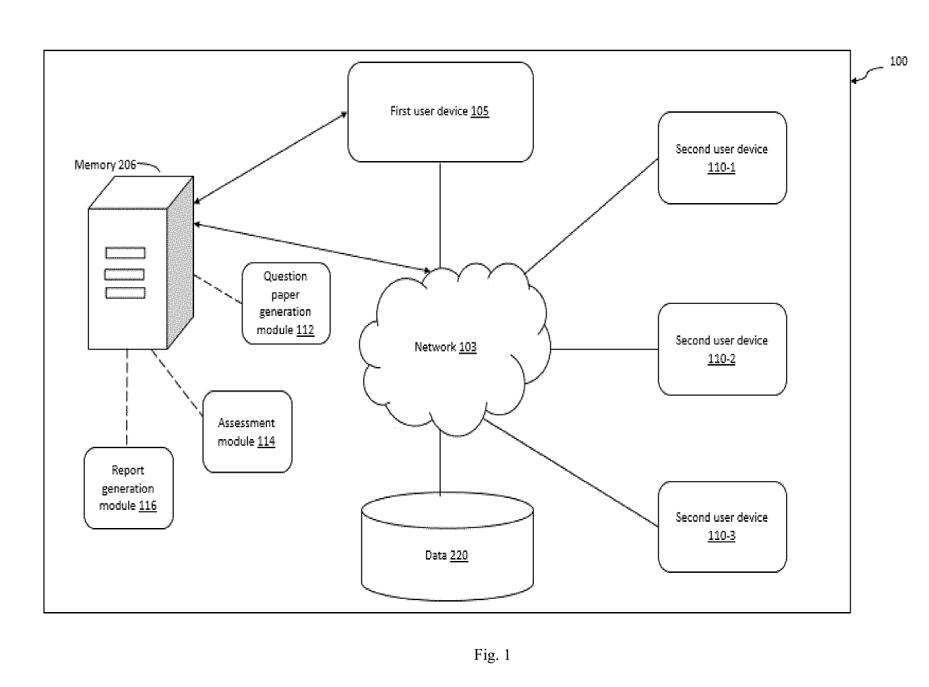

FIG. 1 illustrates a network diagram implementing a dynamic content generation and assessment system 100 describing the interaction between user devices and the generation and assessment of question papers connected to a network 103, in accordance with an implementation of the present invention. Furthermore, data 220, and one first user device 105 and one or more second user devices 110-1, 107-2 . . . 107-N, hereinafter collectively referred to as second user devices 110, are also connected to the network 103. The first user device 105 is connected to memory 206 wherein the memory comprises of a question paper generation module 112, and assessment module 114 and a report generation module 116.

The dynamic content paper generation and assessment system 100 can be implemented as any computing device connected to the network 103. For instance, the computing device includes but not limited to mainframe computers, workstations, personal computers, desktop computers, multiprocessor systems, laptops, network computers, minicomputers, servers and the like. Additionally, the system 100 may include multiple servers to perform single tasks at multiple locations for users, thereby ensuring protection of data in situations wherein a single server may fail to respond to user requests.

Moreover, the examples of the first user device 105 and the second user devices 110 (110-1 . . . 110-n) include, but are not limited to personal computers, desktop computers, smart phones, personal digital assistants, and laptops. The communication links between the first user device 105 and the dynamic content generation system 100 are enabled through a desired form of connections, for example, via dial-up modem connections, cable links, digital subscriber lines (DSL), wireless or satellite links, or any other suitable form of communication. Furthermore, the network 103 may be a wireless network, a wired network, or a combination thereof. The network 103 can also be an individual network or a collection of many such individual networks interconnected with each other and functioning as a single large network, e.g., the internet or an intranet. The network 103 can be implemented as one of the different types of networks, such as intranet, local area network (LAN), wide area network (WAN), the internet and such.

The first user logs in to the network 103 through the first user device 105. The plurality of second users also log in to the network 103 through the second user devices 110. The first user device 105 is connected to the memory 206 wherein the data 220 is fetched from the memory on receiving request from the first user. The data 220 fetched from the memory is used as an input for the question paper generation module 112. The question paper generation module 112 enables the first user to generate the question papers and said generated question papers are displayed to the second user devices 110 through the network 103. Once the responses are obtained from the second user devices 110, it is stored in the data 220 and transmitted to the assessment module 114 through the network 103. The assessment module 114 further assess the responses obtained by the second user devices 110 by at either automatically by matching the responses associated with the questions stored in the data 220 or manually by the first user by entering marks corresponding to each question. The output of the assessment module 114 is internally transmitted to the report generation module 116 to generate personalised reports pertaining to each of the plurality of second users. Such reports are stored in the form of data in data 220. These reports are then displayed on to the second devices 110 and first user device 105 through the network 103.

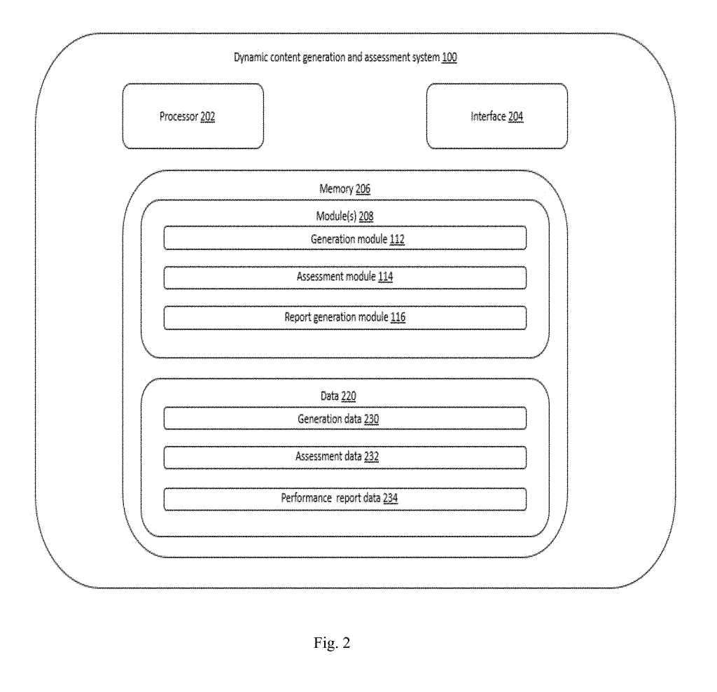

FIG. 2 illustrates the dynamic content generation and assessment system 100, in accordance with an implementation of the present disclosure. In said implementation, the dynamic content generation and assessment system 100 includes one or more processor(s) 202, interface(s) 204, and a memory 206 coupled to the processor 202. The processor 202 can be a single processing unit or a number of units, all of which could also include multiple computing units. The processor 202 may be implemented as one or more microprocessors, microcomputers, microcontrollers, digital signal processors, central processing units, state machines, logic circuitries, and/or any devices that manipulate signals based on operational instructions. Among other capabilities, the processor 202 is configured to fetch and execute computer-readable instructions and data stored in the memory 206. In one implementation, the dynamic content generation and assessment system 100 includes a question paper generation module 112, an assessment module 114 and a report generation module 116.

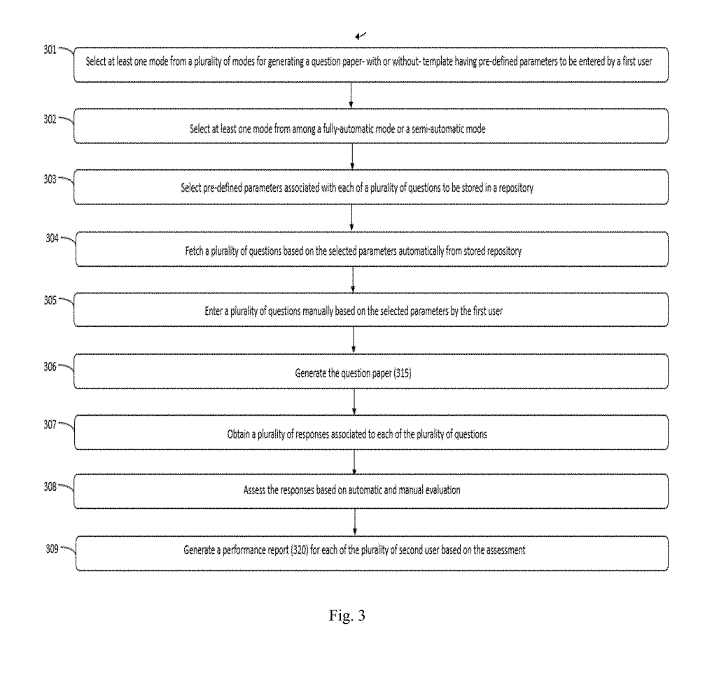

The stored repository may be an externally hosted data repository such as data 220, or may be stored within the dynamic content generation and assessment system 100. In one example, the first user may utilize the first user device 105 to specify the parameters to fetch the questions to dynamic content generation and assessment system 100 via the network 103. In one implementation, the first user may create a question paper template via the network 103. For example, the pre-defined template may include parameters based on which the questions are retrieved from the stored repository. The questions thus retrieved may be used to populate the question paper template to generate the question paper. The manner in which the dynamic content generation and assessment system 100 generates said question papers and assess the responses are further described in conjunction with FIG. 3.

FIG. 3 illustrates a method to generate and assess a customised question paper. The method 300 may be implemented in a variety of computing systems, mentioned in description of FIG. 1 and FIG. 2, in several different ways. For example, the method 300, described herein, may be implemented using the dynamic content generation and assessment system 100, as described above.

The order in which the method 300 is described is not intended to be construed as a limitation, and any number of the described method blocks can be combined in any order to implement the method, or an alternative method. Additionally, individual blocks may be deleted from the method without departing from the spirit and scope of the subject matter described herein. Furthermore, the methods can be implemented in any suitable hardware, software, firmware, or combination thereof. It will be understood that even though the method 300 is described with reference to the dynamic content generation and assessment system 100, the description may be extended to other systems as well.

At block 301, a first user may select at least one from a plurality of modes for generating a question-paper by selecting a with-template or a without-template mode. The with-template mode consists of templates generated by various sources such as educational institutions, or any user that are stored in the system. In one implementation, the question paper template may be received from a user. In one implementation, pre-defined templates based on existing formats may be available in the customised question paper generation system 100, and may be provided to the first user for selection. In such a case, the user may select a suitable question paper template based on their requirements.

At block 302, the first user may select one mode from among a programmed mode or a semi-automatic programmed mode. The programmed mode is defined to be a fully-automatic mode that requires the first user to select a minimum amount of parameters at block 303 based on which the question paper 315 is generated. Furthermore, the semi-automatic mode requires the first user to select more number of parameters at block 303 as opposed to the fully-automatic mode.

At block 304, in an embodiment, the dynamic content generation and assessment system 100 fetches a plurality of questions automatically from the stored repository based on the parameters selected by the user. In an implementation, the said repository may be stored in the dynamic content generation and assessment system 100.

At block 305, in another embodiment, the first user can enter a plurality of questions manually on the first user device 105 and associate the question with the pre-defined parameters. Based on the above-described method and parameters, a question paper 315 is generated at block 306.

Furthermore, at block 307, the generated question paper is shared onto the plurality of second user devices 110. The plurality of second users inputs their responses to the said questions on the plurality of second user devices 110. The assessment data is then 232 is fetched from the plurality of second user devices 110 and sent to the memory 206 for assessing via the assessment module 114.

At block 308, the assessment module 114 validates the data by matching it through the data stored in the stored repository. The assessment module contains the assessment data 232 which is processed by the processor 202 in conjunction with the memory 206. The output of the assessment module 114 is then fed to report generation module 116.

At block 309, a performance report 320 is generated for each of the plurality of second user based on the output of the assessment module 114. The performance report 320 may be distributed among a plurality of similar first users and may be distributed via network 103 to a plurality of first user devices. Such distributed system ensures reusability of the generated question papers.

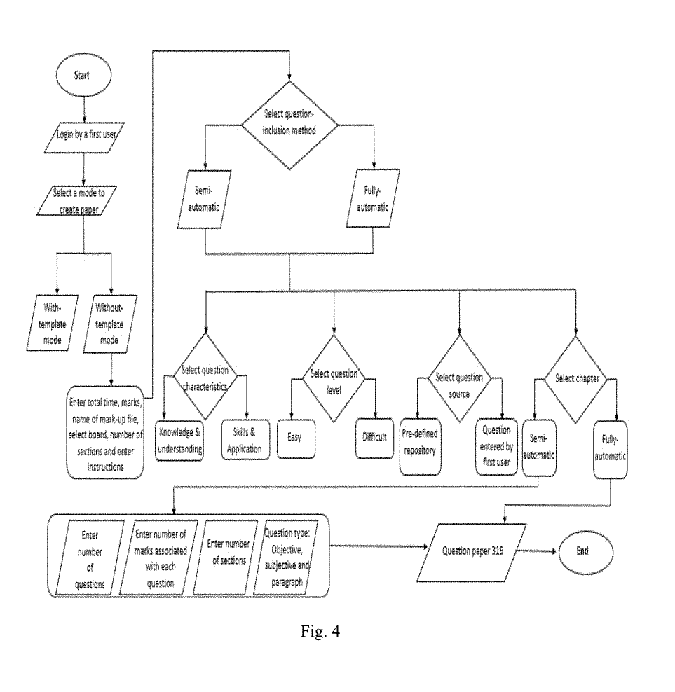

FIG. 4 illustrates a detailed method to generate and assess a question paper describing the various modes and set of pre-defined parameters to be selected by a first user to generate the question paper.

In an embodiment, the question paper may be generated through one or more modes such as a with-template mode and a without-template mode. Further, the embodiment includes generating a question paper using a with-template mode. The with-template mode further requires selecting a fully-automatic mode wherein the user selects a pre-defined template to generate the question paper by providing parameters such as a board, a class, a subject, a question paper name, a question characteristic comprising at least one of a knowledge, an understanding, a skill and an application, a plurality of instructions, a plurality of chapters and a difficulty level of said questions, wherein the difficulty level comprises at least one of an easy level and a difficult level automatically fetched from the stored repository associated with each question. The board herein includes but not limited to ICSE board, CBSE board, ISC Board and other regional boards of the country. Moreover, the system may be customised according to the requirement of any country's educational system.

In the said embodiment, the user selects a pre-defined template/structure of the question paper in which and the dynamic content generation and assessment system 100 automatically fetches the questions from stored repository into the said template. Such pre-defined templates may be created by any educational institution using the interface provided to the users by logging in through authenticated credentials.

Moreover, in the embodiment described above, the first user logins to the dynamic content generation system 100 as a teacher and selects the option of “create paper” using “with-template mode”. The first user is asked to select from among a plurality of pre-defined parameters including but not limited to a board, a class, a subject, name of the question paper. The method further allows the first user to include questions in the paper in an automatic fashion wherein the questions are automatically populated in the question paper 315 from the repository. The first user is prompted to select question characteristics including but not limited to at least one of a knowledge, understanding and skills, application. The said characteristics are associated with the plurality of questions stored in the stored repository. The method further allows the first user to select the difficulty level of the questions including but not limited to easy and difficult along with the source of the questions. In an implementation, the questions may be populated from the stored repository. The first user can enter instructions to be displayed in the paper and select chapters from among the plurality of chapters. The template consists of pre-defined information including but not limited to a maximum marks, a total time of the question paper, number of sections and the type of question.

In another embodiment, the question paper 315 is generated using the without-template mode. In an implementation, the without-template mode further allows a first user to select a fully-automatic mode of question paper generation wherein the system automatically creates the template/structure of the paper in run-time with minimal pre-defined criteria and further automatically populates questions in the question papers from the stored repository. The first user logins to the dynamic content generation and assessment system 100 as a teacher and selects “create paper” using “without template” mode. The first user needs to enter a plurality of pre-defined minimal parameters including but not limited to a total time, a maximum marks ranging 50-100, number of sections and question type. The question type includes an objective type, a subjective type and a paragraph type questions. The first user is further prompted to select from among a plurality of pre-defined parameters including but not limited to a board, a class, a subject, name of the question paper 315. wherein the set of second pre-defined parameters for fully-automatic mode includes but not limited to the set of first pre-defined parameters and a total time determined automatically based on the selected mode, a maximum marks ranging from 50 to 100, a plurality of sections entered by the first user and the question type.

The method further allows the first user to include questions in the paper in an automatic fashion wherein the questions are automatically populated in the question paper 315 from the repository. The first user is prompted to select question characteristics including but not limited to at least one of a knowledge, understanding and skills, application. The said characteristics are associated with the plurality of questions stored in the stored repository. The method further allows the first user to select the difficulty level of the questions including but not limited to easy and difficult along with the source of the questions. wherein the set of second pre-defined parameters for fully-automatic mode includes but not limited to the set of first pre-defined parameters and a total time determined automatically based on the selected mode, a maximum marks ranging from 50 to 100, a plurality of sections entered by the first user and the question type.

In another implementation, the without-template mode further allows a first user to select a semi-automatic mode of question paper generation wherein the system 100 provides the first user an option to create only manually a new structure/template of question and define the types of questions and manually pick up the questions from each chapter. The first user logins to the dynamic content generation and assessment system 100 as a teacher and selects “create paper” using “without template” mode. The first user needs to enter a plurality of pre-defined minimal parameters including but not limited to total time, maximum marks, board, class, subject, name of the question paper, instruction, chapters. The first user is further allowed to select the option as “semi-automated” that enables the first user to provide limited criteria to create a template of the paper in real-time fashion and allows the questions to be automatically populated in the question paper 315 based on the second set of pre-defined parameters. The second set of pre-defined parameters for semi-automatic mode of question paper generation includes but not limited to number of questions of the selected type of question to be included from the corresponding chapter, mark associated with each question type and a section under which the specified number of questions of the selected type and marks can be incorporated from the corresponding chapter.

The question paper 315 once generated is shared with the plurality of second user devices 110 through the network 103. The question paper 315 may be further assessed by the assessment module 114 and the output is fed to the report generation module 116. The report generation module 116 may assess the performance report data 234 and may generate a customised performance report 320 for each of the plurality of second users. The performance report 320 may be shared with different users over the distributed network 103.

The embodiments and implementations described above are illustrative examples and it should not be construed that the present invention is limited to these particular embodiments. Thus various changes and modifications may be effected by one skilled in the art without departing from the spirit or scope of the invention as defined in the appended claims.

We claim:

1. A method for generation and assessment of a question paper, the method comprising steps of:
selecting at least one mode from among a plurality of modes; wherein at least one of the plurality of modes comprise a fully-automatic programmed mode configured to automatically generate the question paper based on a set of first pre-defined parameters selected by a first user;
selecting at least one mode from among the plurality of modes; wherein at least one of the plurality of modes comprises at least one of the programmed mode and a semi-programmed mode; wherein the question paper is either automatically or semi-automatically generated based on a set of second pre-defined parameters selected by the first user;
fetching a plurality of questions automatically from a repository based on the set of pre-defined parameters selected by the first user in the selected mode;
entering a plurality of questions manually by the first user based on the set of pre-defined parameters selected in the selected mode;
producing the question paper based on the set of pre-defined parameters and at least one mode selected by the first user;
obtaining a plurality of responses associated to the question from a plurality of second users wherein the responses are aligned with at least one or more question type;
assessing the responses obtained from the plurality of second users, wherein the assessment is validated automatically based on matching of the question with responses from the repository and manually by the first user by providing manual remarks and marks associated with each question.

2. The method as claimed in claim 1, wherein the plurality of modes for question paper generation consist of at least one of a with-template mode and a without-template mode; wherein the with-template mode further comprise the fully-automatic programmed mode and the without-template mode further comprises the programmed mode and the semi-programmed mode.

3. The method as claimed in claim 1, wherein the plurality of questions retrieved from the repository is associated with a difficulty level, a question type, and a question characteristic.

4. The method as claimed in claim 1, wherein the set of first pre-defined parameters includes but not limited to a difficulty level of said questions, wherein the difficulty level associated with each question comprises at least one of an easy level and a difficult level automatically fetched from the stored repository associated with each question.

5. The method as claimed in claim 1, wherein based on the assessment, a performance report is generated corresponding to each of the plurality of second users.

6. The method as claimed in claim 1, wherein the responses are validated automatically for the objective question type based on matching of the question with responses from the repository.

7. The method as claimed in claim 1, wherein the responses are validated manually by the first user for the subjective and paragraph question type by entering marks and providing remarks associated with each of the plurality of questions.

8. The method as claimed in claim 1, wherein the generation and assessment of question paper is based on a customised method.

9. A system for generation and assessment of a question paper, the system comprising:
a processor;
a memory coupled to the processor, the memory comprising:
a generation module configured to generate the question paper, based on a plurality of modes selected by a first user, a set of first pre-defined parameters and a set of second pre-defined parameters, and a plurality of questions fetched from a stored repository;
an assessment module configured to assess the question paper, based on a plurality of responses associated to the plurality of questions obtained from a plurality of second user; and
a report generation module configured to generate a performance report based on the assessment.

10. The system as claimed in claim 9, wherein the plurality of modes comprise a with-template mode and a without-template mode.

11. The system as claimed in claim 9, wherein the generation module is configured to receive the set of first pre-defined parameters and the set of second pre-defined parameters and the selected mode.

12. The system as claimed in claim 9, wherein the set of first pre-defined parameters includes but not limited to a difficulty level of said questions, wherein the difficulty level comprises at least one of an easy level and a difficult level automatically fetched from the stored repository associated with each question.

13. The system as claimed in claim 9, wherein the set of second pre-defined parameters include but not limited to the set of first pre-defined parameters and a total time, a maximum marks, a number of sections wherein the section includes a number of questions associated with a question type, wherein each question is tagged with a mark; the question type wherein the question type includes but not limited to an objective type, a subjective type and a paragraph type.

14. The system as claimed in claim 9, wherein the generation module is configured to fetch the plurality of question from the stored repository.

15. The system as claimed in claim 9, wherein the generation module is further configured to provide the question paper to at least one second user device.

16. The system as claimed in claim 9, wherein the assessment module is configured to receive responses from at least one second user device.

17. The system as claimed in claim 9, wherein the report generation module is configured to generate the performance reports for each of the plurality of second user.
